(19) United States
(12) Patent Application Publication
(10) Pub. No.: US 2019/0327358 A1
(43) Pub. Date: Oct. 24, 2019

(54) METHOD OF CONTROLLING MOBILE DEVICES IN CONCERT DURING A MASS SPECTATORS EVENT WITH A BEACON BASED NETWORK

(71) Applicant: GAD SERI LEVI, RAMAT GAN (IL)

(72) Inventor: GAD SERI LEVI, RAMAT GAN (IL)

(21) Appl. No.: 16/386,185

(22) Filed: Apr. 16, 2019

Related U.S. Application Data
(60) Provisional application No. 62/659,704, filed on Apr. 19, 2018.

(51) Int. Cl. H04M 1/725; H04W 4/20; H04W 4/30; H04W 4/029

(52) U.S. Cl. CPC H04M 1/72572; H04W 4/20; H04W 84/18; H04W 4/029; H04W 4/30

(57) ABSTRACT

The present invention discloses a system and a method for controlling multiple computerized mobile devices in a mass spectator event, such as a music show, sporting event, political event and the like where the usage of traditional networks such Wi-Fi or Cellular is not feasible economically or technically due to the limited bandwidth. The present invention discloses a method whereby a network of beacons, and, optionally, the GPS location is used to synchronize, coordinate, and control the selection and execution of a sequence of actions on the mobile devices such as playing video, playing vibrations, playing camera flash patterns, illuminating screen patterns, illuminating screen colors, displaying images, displaying texts, playing sounds, or playing music.

### CROSS REFERENCE TO RELATED APPLICATIONS

This application is related to PCT International Application No. PCT/IL2016/050278 filed on Mar. 13, 2016, and WO2016147176A1 filed on Sep. 22, 2016 and claims the benefit of U.S. Provisional Patent Application No. 62/132,950 filed on Mar. 13, 2015.

### FIELD OF THE INVENTION

The present invention generally relates to controlling mobile devices and other peripherals via remote devices, and more specifically to a method for controlling mobile devices in a synchronized and coordinated fashion in a mass spectator event where a traditional network infrastructure like Wi-Fi or Cellular are not technically or economically feasible or cannot be deployed unreliable in the venue. Instead of a traditional Wi-Fi or Cellular network, a network of beacons is used to activate various actions on the mobile devices in a spectator event.

### BACKGROUND OF THE INVENTION

The current solutions to augment the user experience in spectacle events using the users' mobile devices rely on traditional networks such as Wi-Fi or Cellular where each device is both a transmitter and receiver the network and, as such, needs to share the overall network bandwidth to send and receive data, including the network protocol data that is required to facilitate communications. These networks tend of work well in environments where radio noise between devices is relatively low and the network bandwidth is sufficiently large to enable the required data to arrive at each device reliably.

There is a need for providing a mechanism where mobile devices in mass spectator events can be commanded reliably without a traditional network such as Wi-Fi or Cellular.

### SUMMARY OF THE INVENTION

It is an object of the present invention to disclose a method of controlling multiple mobile electronic devices using a network of beacons where each beacon transmits a set of predefined data to the mobile devices. The mobile devices, in turn, are set up to accept these predefined beacon data transmissions and, based on the value of the received data, activate a sequence of predefined actions such as vibrations, LED flashes, playing of video files, playing of audio files, illuminating the LCD in different colors, displaying images, or process user movements to simulate musical instruments.

It is also an object of the present invention to disclose a method of using the device's GPS coordinates to control and activate various actions on the device.

In some cases, all the content files and sequences of commands are pre-loaded into the mobile devices before the event starts. This is because the network cannot be relied upon to support the dynamic loading to contents files and other data at the time and place of the event. The mobile device software is set up to monitor the transmission bursts of data from the beacon and, based on the received data, activate a sequence of actions. For example, when the beacon transmits its minor and major identification number, the mobile devices can map these number into a sequence of actions.

In some cases, the beacon network can be configured to transmit the individual commands the mobile device application expects to execute a particular command such as vibrate the device, illuminate the LCD screen, or start playing a video file.

In some cases, the beacon network can be configured to propagate predefined signals to other beacons which, in turn, activate actions on mobile devices in their vicinity. As an example, this concept can be used to guide the audience “wave” at a football game.

In some cases, the beacon data transmitted is used in conjunction with the devices GPS location to select the place and start time of an action or sequence of action. As an example of this use case, the American flag can be painted on the audience in a baseball game using the mobile devices LCD screen.

In some cases, the beacon data can contain both the identifier for the sequence of events to trigger as well as the start time to start executing the sequence.

In some cases, the timing of the actions is programmed into the beacon network such that the beacons propagate the data between them in a synchronized coordinated fashion and, as a result, the actions on the mobile devices are triggered in a synchronized coordinated fashion.

In some cases, the sequence of defined actions on the mobile devices are programmed to start at a predefined absolute time but the sequence itself is determined by the closest beacon to the mobile device.

In some cases, the GPS location is used to determine that start time of the sequence of actions but the sequence itself is determined by the closest beacon to the mobile device.

1. A method of controlling a plurality of mobile electronic devices at an audience event using a network of beacons, the method comprising:
a) preparing a unique configuration and content data for the mobile devices for the specific event.
b) downloading a mobile software application onto each mobile electronic device along with the items in (a);
c) configuring a network of beacons for the specific venue;
d) installing a network on beacon at the venue;
e) launching the mobile software application onto each mobile electronic device during the audience event;
f) the mobile software application obtains its GPS location;
g) the mobile software application received data from the beacons;
h) using the beacon data and, optionally, the GPS location, the mobile devices software would activate a sequence of actions on the mobile device from a group consisting of playing video, playing vibrations, playing camera flash patterns, illuminating screen patterns, illuminating screen colors, displaying images, displaying texts, playing sounds, or playing music.

2. The method of claim 1, wherein the mobile device software uses the beacon data to select and start the execution of a sequence of actions on the mobile device from the group consisting of playing video, playing vibrations, playing camera flash patterns, illuminating screen patterns, illuminating screen colors, displaying images, displaying texts, playing sounds, or playing music.

3. The method of claim 1, wherein the mobile device software uses the beacon data and GPS coordinate to select and start the execution of a sequence of actions on the mobile device from the group consisting of playing video, playing vibrations, playing camera flash patterns, illuminating screen patterns, illuminating screen colors, displaying images, displaying texts, playing sounds, or playing music.

4. The method of claim 1, wherein the beacons are configured to propagate signals to the mobile devices used to select the sequence of actions along with timing data used to set the start time of the sequence of actions.

5. The method of claim 1, wherein the beacons are configured to propagate signals to the mobile devices in a synchronous coordinated fashion such that the mobile devices will start the execution of a sequence actions in a synchronous coordinated fashion.

6. The method of claim 1, wherein the beacons are configured to transmit specific commands to trigger specific actions on the mobile devices from a group consisting of playing video, playing vibrations, playing camera flash patterns, illuminating screen patterns, illuminating screen colors, displaying images, displaying texts, playing sounds, or playing music.

7. The method of claim 1, wherein the beacons are configured to transmit specific commands to trigger specific actions on the mobile devices from a group consisting of playing video, playing vibrations, playing camera flash patterns, illuminating screen patterns, illuminating screen colors, displaying images, displaying texts, playing sounds, or playing music. And the start time of the sequence of actions is determined by the GPS location derived by the mobile device.

8. The method of claim 1, wherein the mobile device software uses the beacon data to select the sequence of actions on the mobile device with a predefined start time that is encoded in the sequence of actions.
